(19) United States
(12) Patent Application Publication
(10) Pub. No.: US 2003/0182666 A1
(43) Pub. Date: Sep. 25, 2003

(54) Service-quality management system for asymmetric digital subscriber line

(76) Inventor: Gang-Jae You, Yongin-city (KR)

Correspondence Address: Robert E. Bushnell, Suite 300, 1522 K Street, N.W., Washington, DC, 20005-1202, US

(21) Appl. No.: 10/370,116

(22) Filed: Feb. 21, 2003

(30) Foreign Application Priority Data
Mar. 19, 2002 (KR) 2002-14821

(51) Int. Cl. H04N 7/173

(52) U.S. Cl. 725/111; 725/124

(57) ABSTRACT

A service-quality management system for an asymmetric digital subscriber line ADSL, while the ADSL service is provided to each subscriber terminal of the ADSL network, comprising: a digital subscriber-line access multiplexor DSLAM, connected with numerous subscriber modems coupling with each corresponding subscriber terminal, collecting a subscriber line based on asynchronous transfer mode ATM, checking link states of each subscriber modem in real time to detect link up/down data, and outputting a message of link up/down data including the detected data and the associated operation parameter data; and a network management device performing function of storing, managing, and outputting the link up/down data and the associated operation parameter data of each subscriber modem included in the message of link up/down data from the DSLAM. According to the present invention, the service quality management system for ADSL prevents a problem of the ADSL network, such as transmission troubles and copes with a generated trouble rapidly, which results in improving service qualities of the ADSL.

### CLAIM OF PRIORITY

This application makes reference to, incorporates the same herein, and claims all benefits accruing under 35 U.S.C § 119 from an application entitled Service-Quality Management System for Asymmetric Digital Subscriber Line earlier filed in the Korean Industrial Property Office on 19 Mar. 2002, and there duly assigned Serial No. 2002-14821 by that Office.

### BACKGROUND OF THE INVENTION

1. Field of the Invention

The present invention relates to a service-quality management system providing link states of each subscriber modem in an asymmetric digital subscriber line ADSL and operation parameter data related to the link states through a graphic user interface GUI in a bundle, in real time or in time of a manual research.

1. Description of the Related Art

Generally, a digital subscriber line DSL is a transmission method providing a bi-directional wideband high data service to a home or a company through general telephone line (POTS: plain old telephone service), a copper line, known as a twisted pair wire.

In DSL, there are various kinds, such as asymmetric digital subscriber line ADSL, a high bit-rate digital subscriber line HDSL, a symmetric high speed digital subscriber line SHDSL (or G.SHDSL), and a very high data rate digital subscriber line VDSL. Reference to the group of various DSL systems is xDSL.

ADSL among the above described xDSL is suitable to provide a high speed Internet service 8 for a home and a small and medium-sized company, and is commonly used. FIG. 1 is a block diagram illustrating a service network configuration for providing a conventional service of an asymmetric digital subscriber line.

As shown in FIG. 1, the ADSL service network installed within a home of a subscriber comprises a subscriber modem 20, a digital subscriber-line access multiplexor DSLAM 30, an asynchronous transfer mode ATM network 40, and a certification/conversion device 50. The subscriber modem 20 is connected with a subscriber terminal (a computer terminal) 10, and the DSLAM 30 is installed in a service providing company, such as a telephone company's cental office, to collect a subscriber line based on the asynchronous transfer mode ATM. The ATM network 40 is a backbone network of the DSLAM 30, and the certification/conversion device 50 performs a certification function and mutual conversion to an ATM data and a packet data to interface the ATM network 40 with an Internet network 60.

Therefore, when an Internet user, a subscriber, turns on the subscriber terminal 10 to receive an ADSL service, a certification and a connection program pre-installed in the subscriber terminal are practiced. After getting a certification from the service providing company, the Internet user is connected with the high-speed Internet service provided by the ADSL system.

When the high-speed Internet service is activated, the service providing company has to manage numerous subscribers, and a service quality can be lowered according to the various environs around and characteristics of the subscriber line.

Due to the deteriorated service quality, the service providing company has to increase maintenance costs, promote enormous investment for the service restoration, and mobilize numerous workers for an after-sales service. Additionally, the deteriorated service quality can give bad cooperate image to the corresponding service providing company and higher dissatisfaction to a subscriber, and it is necessary for the service providing company to improve the service quality.

As described above, service quality management for preventing deterioration of the ADSL service quality is important to both a service providing company and a subscriber. To decide such deterioration of the service quality in the conventional system, data of all subscriber modems should be searched directly.

In other words, the conventional DSLAM 30 provides an operational characteristic parameter data of the subscriber modem 20, such as present speed, a margin value of signal to noise ratio SNR, and an occurrence count of a cyclic redundancy checking CRC code. Therefore, the service providing company has to analyze those three kinds of data to decide whether the service quality is deteriorated or not.

However, it is almost impossible to decide the correct service quality deterioration by using those three kinds of data. Therefore, most operators in the service providing company receive a failure call from the Internet user to decide a deterioration degree of the service quality. When receiving the failure call from the Internet user, the operator resets a corresponding subscriber modem port, or inserts and restarts the corresponding connection unit after extracting the connection unit, so that the failure subscriber modem is connected to the network again.

Therefore, in the conventional system, workloads become severe to a part of the service providing company treating the failure call from the Internet user, and it is almost impossible to grasp correctly the cause of the deterioration of the service quality. Additionally, the occurrence of unnecessary after-sales services results in wasting human and material resources, and makes it difficult to analyze the deterioration of the service quality.

The above described problems ultimately fall short of service reliability and generate the deterioration of the service quality.

### SUMMARY OF THE INVENTION

To overcome the above described problems, preferred embodiments of the present invention provide a service quality management system for ADSL, managing operation parameter data and link states of each subscriber modem in ADSL in a bundle. Therefore, the service quality management system for ADSL according to the present invention prevents a problem of the ADSL network, such as transmission troubles and rapidly copes with a generated trouble, which results in improving service qualities of the ADSL.

An object of the present invention is to provide a service network applying a service-quality management system for an asymmetric digital subscriber line ADSL, while the ADSL service is provided to each subscriber terminal of the ADSL network

The a service network applying the service-quality management system to the asymmetric digital subscriber line ADSL comprises: a digital subscriber-line access multiplexor DSLAM connected with numerous subscriber modems coupling with each corresponding subscriber terminal, collecting a subscriber line based on the asynchronous transfer mode ATM, checking link states of each subscriber modem in real time to detect link up/down data, and outputting a message of link up/down data including the detected data and the associated operation parameter data; and a network management device performing function of storing, managing, and outputting the link up/down data and the associated operation parameter data of each subscriber modem included in the message of link up/down data from the DSLAM.

Additionally, the operation parameter data includes at least one of a maximum transmission speed, a present speed, a margin of signal to noise NSR ratio, and a line mode.

The network management device comprises: a network interface unit performing an interface function with the DSLAM to receive the message of link state data from the DSLAM; a data base storing link up/down data and associated operation parameter data for each subscriber modem, included in the message of link up/down data; a display unit displaying link up/down data and associated operation parameter data for each subscriber modem stored in the data base; and a controller controlling mutual operations and data flows among the network interface unit, the data base and the display unit.

Additionally, the data base stores occurrence times and occurrence counts, when storing link up/down data.

Also, the display unit provides a graphic user interface GUI that an operator can easily recognize, and a function window fit on the operator's requests.

Further, the function window includes a search window searching the link up/down data and the associated operation parameter data for each subscriber modem, stored in the data base, s according to the operator's requests.

Further yet, the search window includes a search function window searching history data of link occurrence counts for each subscriber, wherein the search function window comprises: a system ID selection item selecting more than one of the DSLAMs managed by the operator; a history range selection item selecting a searching period; and a count selection item of link states change, inputting the count of link up/down states to search a subscriber modem having a specified condition or more.

And still even further, the display unit outputs link up/down data in real time.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram illustrating a service network configuration for providing a conventional service of an asymmetric digital subscriber line;

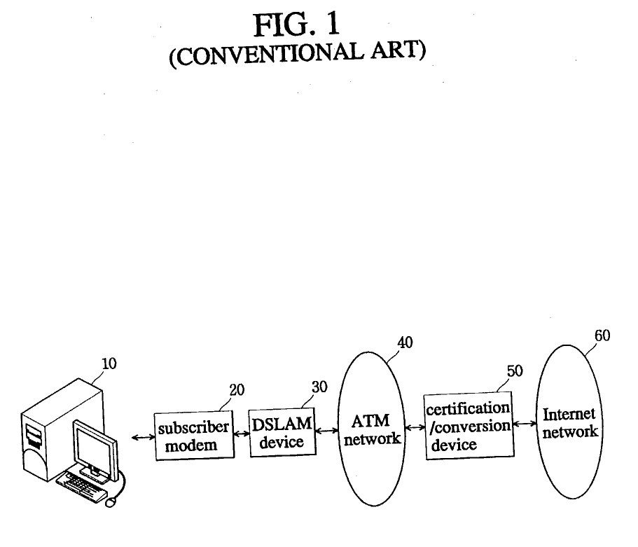

FIG. 2 is a block diagram illustrating a service network applying a service-quality management system to an asymmetric digital subscriber line ADSL according to the preferred embodiment of the present invention;

FIG. 3 is a block diagram illustrating a configuration of the network management device according the preferred embodiment of the present invention;

FIG. 4 is an example of a search function window searching history data of link occurrence counts in a display unit;

FIG. 5 is an example window displaying history data of link change times to a subscriber modem; and

FIG. 6 is an example window of an actual link status change according to a margin change of signal to noise ratio SNR.

### DETAILED DESCRIPTION OF PREFERRED EMBODIMENTS

Reference will now be made in detail to preferred embodiments of the present invention, example of which is illustrated in the accompanying drawings.

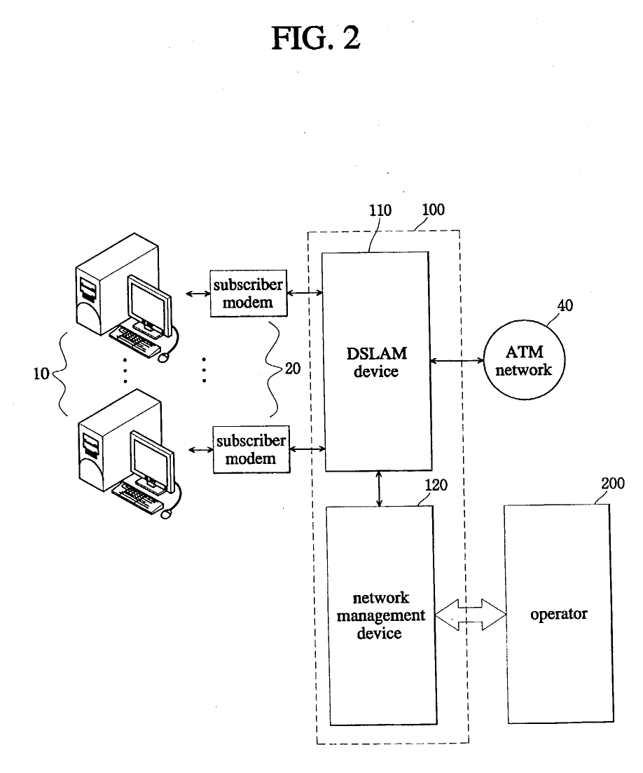

FIG. 2 is a block diagram illustrating a service network applying a service-quality management system to an asymmetric digital subscriber line ADSL according to the preferred embodiment of the present invention. As shown in FIG. 2, the ADSL service-quality management system of the present invention comprises a digital subscriber-line access multiplexor DSLAM 110 and a network management device 120.

The DSLAM 110, connected with numerous subscriber modems 20 coupling with each corresponding subscriber terminal 10, collects the ADSL subscriber line. Additionally, after checking the connection states with each subscriber modem 20 to detect a link up/down state, the DSLAM 110 sends a message including a link up/down state to the network management device 120.

The DSLAM 110 provides a data field of the link up/down message transmitted to the network management device 120, the data field including operation parameter data, such as a maximum transmission speed, a present transmission speed, an SNR margin, and a line mode.

The network management device 120 stores, manages, and outputs to a data base data of link up/down states and of operation parameters of the corresponding subscriber modem 20, included in the message from each subscriber modem 20. An operator 200 analyzes data output by the network management device 120.

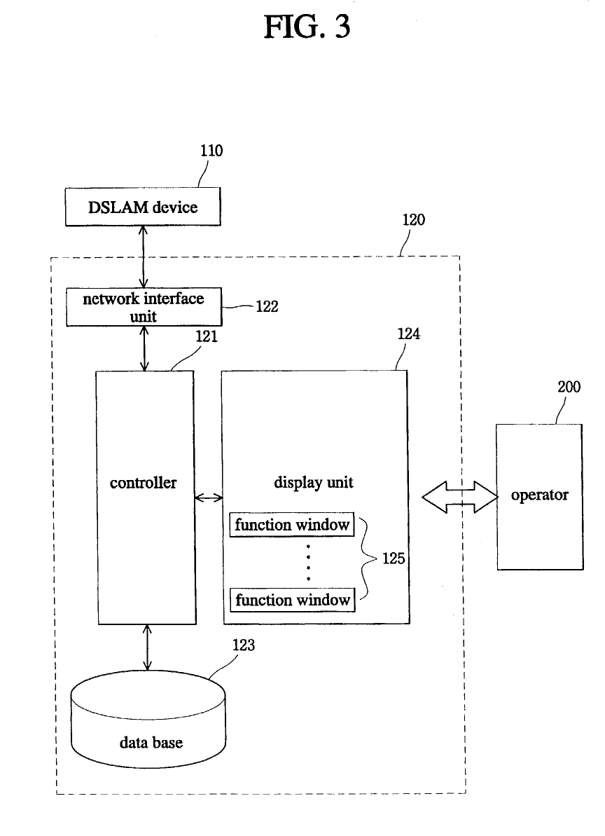

FIG. 3 is a block diagram illustrating a configuration of the network management device 120 according to the preferred embodiment of the present invention. As shown in FIG. 3, the network management device 120 comprises a network interface unit 122, a display unit 124, a data base 123, and a controller 121 controlling mutual operations and data flows among the network interface unit 122, display unit 124 and data base 123, entirely.

The network interface unit 122 performing a network interface function with the DSLAM 110, and receives data of link up/down states according to each subscriber modem 20 from the DSLAM 110.

The data base 123 stores data of link up/down states, data of occurrence times, and data of occurrence counts of each subscriber modem 20 included in the message of link up/down states received through the network interface unit 122, and also stores data of operation parameters.

The display unit 124 displays data of link up/down states and of operation parameters for each subscriber modem 20, stored in the data base 123, in real time. In this case, various function windows 125 are provided, so that an operator 200 can recognize data displayed through the GUI in a single glance. When the operator 200 wants, data in the data base 123, including link up/down states and operation parameters for each subscriber modem 20 can be searched.

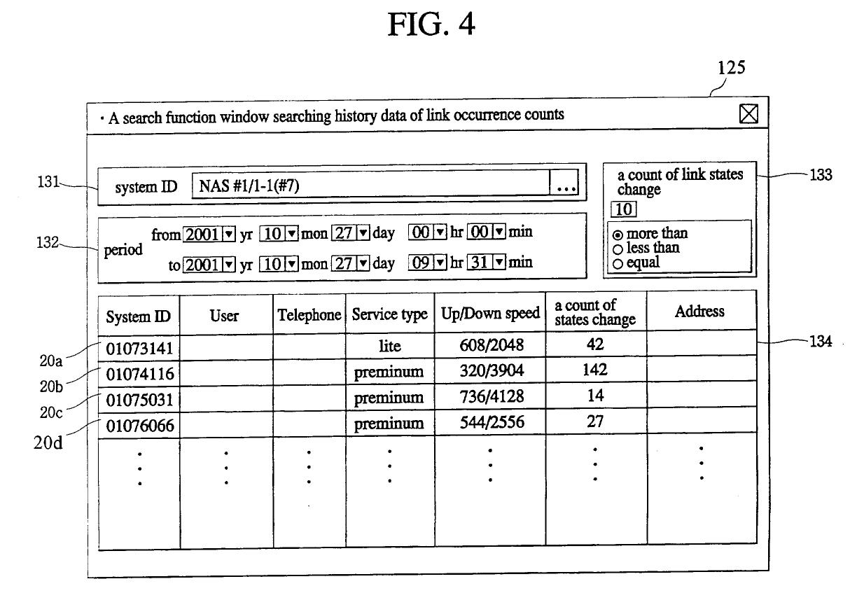

FIG. 4 is an example of a search function window 125 searching history data of link occurrence counts in a display unit. The operator 200 gets the history data of link occurrence counts and an associated data for each subscriber modem 20 through the search function window 125 searching history data of link occurrence counts. Each item in the search function window 125 is illustrated in the following descriptions in detail.

In a system ID selection item 131, more than one of the DSLAMs 110 is selected to be managed by the operator 200. In a history range selection item 132, a searching period is selected. In a count selection item of the link states change 133, by inputting the count of link up/down states, a subscriber modem 20 having specified conditions is searched.

Therefore, the link change states of each subscriber modem 20, managed by the operator 200, are reviewed by inputting specified conditions to the search function window 125 and by examining the result of the search function window 125. As a result, data transmission qualities and states in a corresponding subscriber can be recognized.

In more detail, in the search function window 125 searching history data of link occurrence counts of FIG. 4, the number ‘10’, for example, is inputted to the count selection item of the link states change 133. After searching subscriber modems changing link states more than 10 a day, information of the corresponding subscriber modems 20a, 20b, 20c and 20d found is displayed. As a result, the subscriber modem 20b having the system ID of ‘01074116’, displays ‘142’ in the field of a count of (link) states change, which means the subscriber modem 20b has 142 link state changes during the period 132 searched.

The above described phenomena can happen, when operation parameter data, such as an SNR margin and speed, set to the subscriber modem 20b are not matched with the line's surroundings, or the corresponding subscriber modem 20b is operating abnormally. As a result, the service (uploading and downloading) speed to the corresponding subscriber is influenced severely.

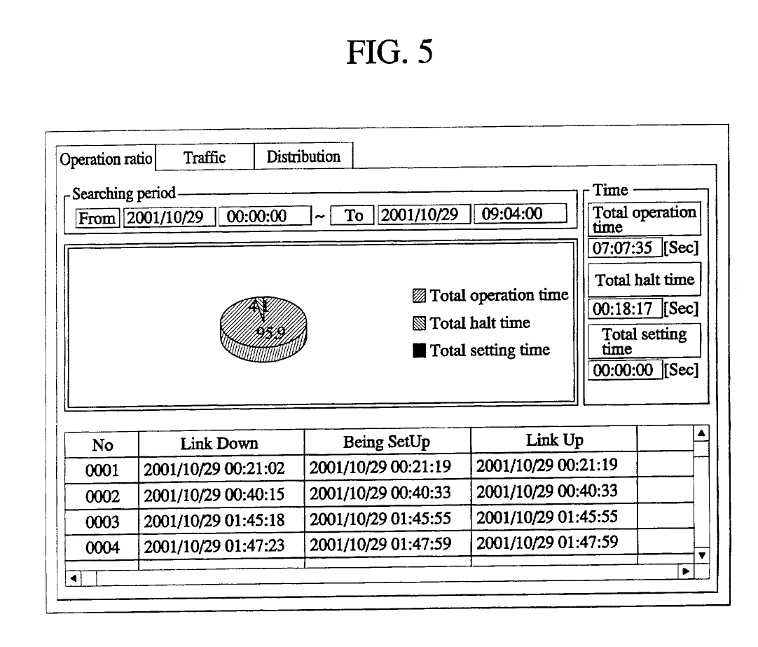

On the contrary, when the operator 200 selects the subscriber modem 20b to output more detail data by a specified method, such as double-clicking the row of the subscriber modem 20b, real link change times are displayed in detail. FIG. 5 is an example window displaying history data of link change times of the corresponding subscriber modem 20b, and is self explanatory.

Therefore, to the subscriber corresponding to the subscriber modem 20b, service quality deterioration, such as low line speed, can be solved through the method of changing of the subscriber modem setting value, such as the SNR margin, changing of the subscriber line, changing of the subscriber modem, and so on. Moreover, the service providing company can solve the problem of the service quality deterioration, before a failure call from the Internet user.

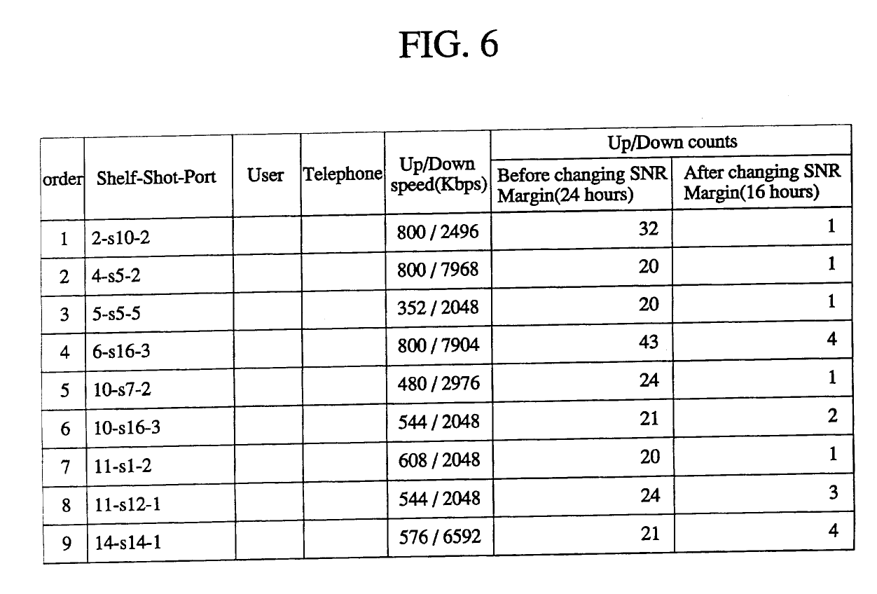

FIG. 6 is an example window of an actual link status change according to a margin change of signal to noise ratio SNR. As shown in FIG. 6, by changing the SNR margin value of the subscriber modems 20 having the same problem with the above described subscriber modem 20b, each subscriber modem 20 is changed to very stable link states.

Additionally, to fit on request of the operator 200, various function windows 125 in the display unit 124 are provided, so that link states in each subscriber modem 20 can be recognized in clear. Therefore, the correct solution can be presented.

As described in the above statements, in the service-quality management system for ADSL according to the present invention, an operator monitors various operation parameters and subscriber link states of each subscriber modem in the ADSL service network in real time or in time of a manual research. Therefore, the service states and quality to each subscriber can be managed.

Additionally, the problem of the ADSL service network happened to each subscriber, such as data transmission troubles, can be prevented. Moreover, a potential problem can be detected and repaired rapidly, before a failure call from the corresponding Internet user. As a result, the ADSL service quality can be improved.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A service-quality management system for an asymmetric digital subscriber line, while an asymmetric digital subscriber line service is provided to a plurality of subscriber terminals of an asymmetric digital subscriber line network, comprising:
a digital subscriber-line access multiplexor, connected with a plurality of subscriber modems coupled to respective ones of said subscriber terminals, for collecting a subscriber line based on asynchronous transfer mode, for checking link states of each subscriber modem in real time to detect link up/down data, and for outputting a message of link up/down data including the detected data and associated operation parameter data; and
a network management device storing, managing, and outputting the link up/down data and the associated operation parameter data of each subscriber modem included in the message output by said digital subscriber-line access multiplexor.

2. The service-quality management system for the asymmetric digital subscriber line service as set forth in claim 1, wherein the operation parameter data includes at least one of a maximum transmission speed, a present speed, a margin of signal-to-noise ratio, and a line mode.

3. The service-quality management system for the asymmetric digital subscriber line service as set forth in claim 1, wherein the network management device comprises:
a network interface unit performing an interface function with the digital subscriber-line access multiplexor to receive the message of link state data from the digital subscriber-line access multiplexor;
a data base storing link up/down data and associated operation parameter data for each subscriber modem, included in the message of link up/down data;
a display unit displaying link up/down data and associated operation parameter data for each subscriber modem stored in the data base; and
a controller controlling mutual operations and data flows among the network interface unit, the data base and the display unit.

4. The service-quality management system for the asymmetric digital subscriber line service as set forth in claim 3, wherein the data base stores occurrence times and occurrence counts, when storing link up/down data.

5. The service-quality management system for the asymmetric digital subscriber line service as set forth in claim 3, wherein the display unit provides a graphic user interface that an operator can easily recognize, and displays a plurality of function windows based on a request by the operator.

6. The service-quality management system for the asymmetric digital subscriber line service as set forth in claim 5, wherein at least one of said function windows includes a search window for searching the link up/down data and the associated operation parameter data for each subscriber modem, stored in the data base, according to a search request by the operator.

7. The service-quality management system for the asymmetric digital subscriber line service as set forth in claim 6, wherein the search window includes a search function window searching history data of link occurrence counts for each subscriber, and wherein the search function window comprises:
a system identification selection item enabling said operator to select more than one of the digital subscriber-line access multiplexors managed by the operator;
a history range selection item enabling the operator to set a search period; and
a count selection item enabling the operator to set a count of link states change to search a count of link up/down states of the subscriber modems.

8. The service-quality management system for the asymmetric digital subscriber line service as set forth in claim 7, wherein said search of a count of link up/down states of the subscriber modems searches for subscriber modems having a number of occurrences of link up/down states more than said count of link states change, less than said count of link states change or equal to said count of link states change.

9. The service-quality management system for the asymmetric digital subscriber line service as set forth in claim 3, wherein the display unit displays link up/down data in real time.

10. A service-quality management system for an asymmetric digital subscriber line, comprising:
a digital subscriber-line access multiplexor, connected with a plurality of subscriber modems coupled to respective ones of a plurality of subscriber terminals, said a digital subscriber-line access multiplexor checking link states of each said subscriber modem in real time to detect link up/down data, and for outputting a message including detected link up/down data; and
a network management device storing, managing, and displaying the detected link up/down data of each said subscriber modem included in said message output by said digital subscriber-line access multiplexor.

11. The service-quality management system as set forth in claim 10, wherein said digital subscriber-line access multiplexor also detects operation parameter data including at least one of a maximum transmission speed, a present speed, a margin of signal-to-noise ratio, and a line mode associated with each said subscriber modem, said operation parameter data being included in said message.

12. The service-quality management system as set forth in claim 11, wherein said network management device comprises:
a network interface unit performing an interface function with the digital subscriber-line access multiplexor to receive the message;
a data base storing link up/down data and operation parameter data for each said subscriber modem;
a display unit displaying the link up/down data and operation parameter data for each subscriber modem stored in the data base; and
a controller controlling mutual operations and data flows among the network interface unit, the data base and the display unit.

13. The service-quality management system as set forth in claim 12, wherein said display unit displays a search function window managed by an operator inputting search criteria, said search function window and search criteria comprising:
a system identification selection item enabling said operator to select any said digital subscriber-line access multiplexor connected to said asymmetric digital subscriber line;
a history range selection item enabling the operator to set a search period; and
a count selection item enabling the operator to set a count of link states change to search a count of link up/down states of the subscriber modems.

14. The service-quality management system for the asymmetric digital subscriber line service as set forth in claim 13, wherein said search of a count of link up/down states of the subscriber modems searches for subscriber modems having a number of occurrences of link up/down states more than said count of link states change, less than said count of link states change or equal to said count of link states change.

15. The service-quality management system for the asymmetric digital subscriber line service as set forth in claim 13, wherein said display unit displays a list of said subscriber modems meeting the search criteria.

16. The service-quality management system for the asymmetric digital subscriber line service as set forth in claim 13, wherein the display unit displays link up/down data in real time of any one of said subscriber modems displayed in said list of said subscriber modems meeting the search criteria and selected by said operator.
